(19) United States
(12) Patent Application Publication
(10) Pub. No.: US 2005/0121091 A1
(43) Pub. Date: Jun. 9, 2005

(54) Removable closure system and plug for conduit

(76) Inventors: Jared Sayers, Red Deer (CA); Tara Dorscher, Calgary (CA); David Ebl, Condor (CA); Doug Hayes, Red Deer (CA); Neil Goetz, Blackfalds (CA); Alain Loyer, Calgary (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/995,311

(22) Filed: Nov. 24, 2004

Related U.S. Application Data
(60) Provisional application No. 60/566,098, filed on Apr. 29, 2004.

(30) Foreign Application Priority Data
Nov. 25, 2003 (CA) 2,450,865

(51) Int. Cl. F16L 55/10

(52) U.S. Cl. 138/89

(57) ABSTRACT

The invention provides a removable closure system comprising a tubular member having an internal surface with an internal profile therein, an entrance end and a plug end, the internal profile providing a dog shoulder and a plug stopping shoulder. A plug assembly is positioned within the tubular member. The plug assembly has a plug suitable for insertion through the tubular member at the entrance end and past the dog shoulder, a plurality of dogs. The dogs are moveable between a collapsed and an expanded condition, the collapsed condition suitable for insertion of the plug assembly through the tubular member past the dog shoulder and the expanded condition suitable for engaging the dog shoulder. When the plug assembly is placed in the tubular member against the plug stopping shoulder, and the dogs are in the expanded condition engaging the dog shoulder, the plug assembly is removably secured in the tubular member.

### CROSS REFERENCE TO RELATED APPLICATION

This application is a regular application claiming priority of U.S. Provisional Patent Application Ser. No. 60/566,098 filed Apr. 29, 2004 and entitled, “NOVEL HOT TAPPING METHOD, SYSTEM AND APPARATUS”, the entirety of which is incorporated herein by reference.

### FIELD OF THE INVENTION

The present invention relates generally to a system for removably placing a device inside a conduit, and more particular to a system for removably placing a plug in a branch pipeline or other tubular member which was hot tapped onto a main pipeline.

### BACKGROUND OF THE INVENTION

In pipeline hot tapping operations it is frequently necessary to close, or to block access to, the interior of a tubular member either permanently or semi-permanently. Pipeline hot taps are used when repairing a defective area of a line without taking it out of service, by setting up a bypass line to provide a path for fluid flow while the defect is repaired. Hot taps may also be used to install a new branch line; again without taking the main pipeline out of service.

After the hot tap operations are completed, tubular members, such as flanges or nipples which are welded onto the main line during the hot tap, may need to be closed or partially blocked. For example, after repairs are complete the openings that provide communication between the main line and bypass line will need to be closed. Preferably the closure is made in such a way that at some future date access can again be obtained through the same opening. Alternatively, in the case of the addition of a branch line, it is often desirable to place a device in the opening which causes pipeline pigs to traverse it, but which still allows for adequate flow of fluid to continue to pass. Without such a blocking device pipeline pigs could lodge themselves in the opening between the main pipeline and branch line.

One conventional means for locking a device in place inside a flange is the Lock-O-Ring™ system from T. D. Williamson, Inc. of Tulsa, Okla. and as disclosed in T. D. Williamson, Inc.'s Bulletin No. 1120.001.01. The Lock-O-Ring™ system utilizes a flange, a retainer ring mounted on an inner cylindrical bore therein, a plug having an annular groove for insertion into the flange and for receiving a portion of the retainer ring, and retainer screws carried in radial passages in the flange for advancing the retainer ring partially into the plug's annular groove thereby locking the plug in place. The T. D. Williamson Bulletin also discloses a plug with guide bars to permit pigs to traverse the opening while allowing for an adequate flow of fluid to continue to pass.

However, the Lock-O-Ring™ system suffers from a number of disadvantages. One primary disadvantage is that it requires the precise coaxial alignment of the plug's annular groove with the retainer ring in the flange, all while rotating the retainer screws to advance the ring. A related problem is that if a worker rotates the screws before the plug is in place, it is possible for the retainer ring's segments to fall into the main pipeline. Furthermore, the Lock-O-Ring™ system provides little, if anything, in the way of feedback to the operator to indicate that it is securely locked in place.

Another system for locking a device in place, inside a flange, is disclosed in U.S. Pat. No. 6,286,553 to Morgan. Morgan teaches a plug which utilizes a radially outward movable snap ring, which engages an annular groove inside a flange, to retain the plug in position. Morgan also discloses an internal circumferential ledge, inside the flange, to assist with the coaxial alignment of the snap ring with the annular groove. Although this solves some of the problems of the prior art, the system is complex, provides little, if any, feedback to indicate that it is securely locked in place, and is generally not suitable to withstand great pressures.

What is needed is a system to removably place a closure plug inside a conduit which is simple, able to withstand great pressures and provides feedback to the operator that it is locked in place.

### SUMMARY OF THE INVENTION

The invention provides a removable closure system comprising a tubular member having an internal surface with an internal profile therein, an entrance end and a plug end, the internal profile providing a dog shoulder and a plug stopping shoulder. In a typical application of the invention the tubular member may be in the form of a flange member, that is, a tubular member that has an integral radially extending flange portion that is readily adaptable for the attachment of other structural or piping devices. In another application of the invention the tubular member may be in the form of a nipple.

A plug assembly is positioned within the tubular member. The plug assembly has a plug, suitable for insertion through the tubular member at the entrance end and past the dog shoulder, and a plurality of dogs. The dogs are moveable between a collapsed and an expanded condition, the collapsed condition suitable for insertion of the plug assembly through the tubular member past the dog shoulder and the expanded condition suitable for engaging the dog shoulder.

When the plug assembly is placed in the tubular member against the plug stopping shoulder, and the dogs are in the expanded condition engaging the dog shoulder, the plug assembly is removably secured in the tubular member.

In certain embodiments of the invention springs are provided to move the dogs to their expanded condition. In other embodiments of the invention a lock ring is provided to move the dogs to their expanded condition. In yet other embodiments, both a lock ring and springs are provided to move the dogs to their expanded condition.

In certain embodiments of the invention a lock ring is provided to keep the dogs in their expanded condition once the plug assembly is removably secured inside the tubular member.

### BRIEF DESCRIPTION OF THE DRAWINGS

FIG. 1 is a sectioned side view of one embodiment of a tubular member having an inner profile suitable for use with the plug assembly of the present invention;

FIGS. 2a-2c are various views of one embodiment of a plug assembly suitable for use with the tubular member of the present invention;

FIGS. 2d-2g are various views of the plug assembly of the embodiment of FIGS. 2a-2c, further showing cap screws, shear posts and shear pins (FIG. 2f is a partial sectional view taken along line X-X in FIG. 2e; FIG. 2g is a sectional view taken along line XX-XX in FIG. 2e);

FIGS. 3a-3c are various views of one embodiment of a setting tool attached to the plug assembly of the embodiment of FIGS. 2a-2g;

FIGS. 4a-4c are various views of one embodiment of a retrieval tool near the plug assembly of the embodiment of FIGS. 2a-2g;

FIG. 5 is a perspective view of the retrieval tool of the embodiment of FIGS. 4a-4c near the plug assembly of the embodiment of FIGS. 2a-2g (the plug shown in an exploded perspective view);

FIGS. 6a-8c are various views of the components of the plug assembly of the embodiment of FIGS. 2a-2g;

FIGS. 9a-10d are various views of the components of the setting tool of FIGS. 3a-3c;

FIGS. 11a-11c are various views of the retrieval tool of the embodiment of FIGS. 4a-4c;

FIGS. 12a-12b are perspective exploded views of a second embodiment of a plug assembly, each figure also showing a lock ring, a shear post assembly, a shear pin and another embodiment of a setting tool (threaded section on the shear post not shown);

FIG. 13 is a sectioned perspective view of the plug assembly of the embodiment of FIGS. 12a-12b;

FIG. 14 is a sectioned perspective view of a third embodiment of a plug assembly, having a pig deflector (or coupon) attached below the plug, shown removably placed inside a second embodiment of a tubular member apparatus, and also showing a lock ring and setting tool;

FIG. 15 is a sectioned perspective view of the plug assembly of FIG. 14, the plug assembly is shown removably placed inside the second embodiment of a tubular member apparatus, the setting tool and shear post having been removed;

FIG. 16 is a perspective view of the plug assembly of FIG. 14, also showing a lock ring and setting tool;

FIGS. 17a-19 are various views of a fourth embodiment of a plug assembly, wherein an alignment ring and a pig deflector are provided, and also showing the second embodiment of the tubular member apparatus;

FIGS. 20-28 are various views of a fifth embodiment of a plug assembly, with a pig deflector but without an alignment ring; and

FIG. 29 is a sectioned perspective view of a sixth embodiment of a plug assembly, which is similar to the fourth embodiment shown in FIGS. 17a-19 but with a longer connecting flange between the plug and the pig deflector so as to operate inside a third embodiment of a tubular member apparatus (also shown).

### DETAILED DESCRIPTION OF THE PREFERRED EMBODIMENTS

Reference is to be had to the Figures in which identical reference numbers identify similar components.

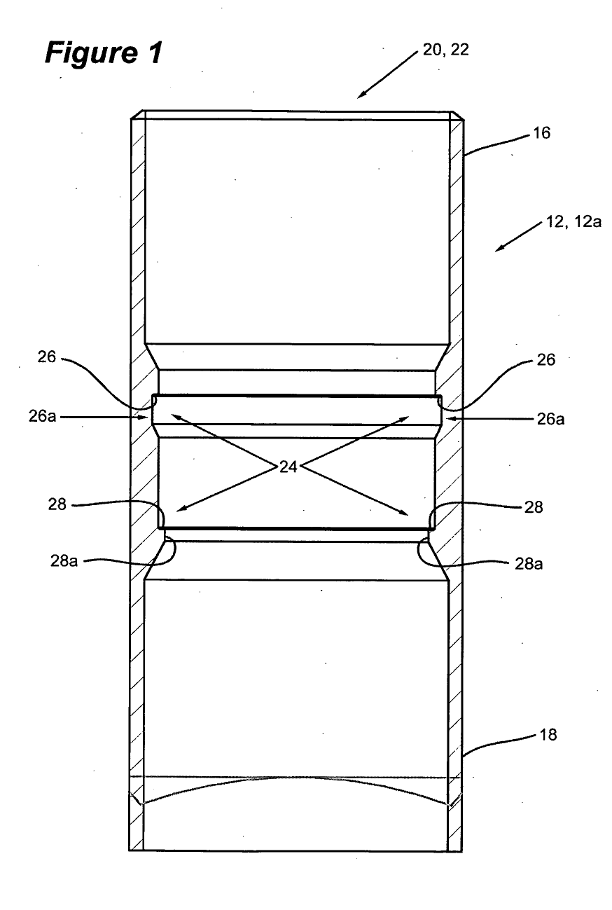

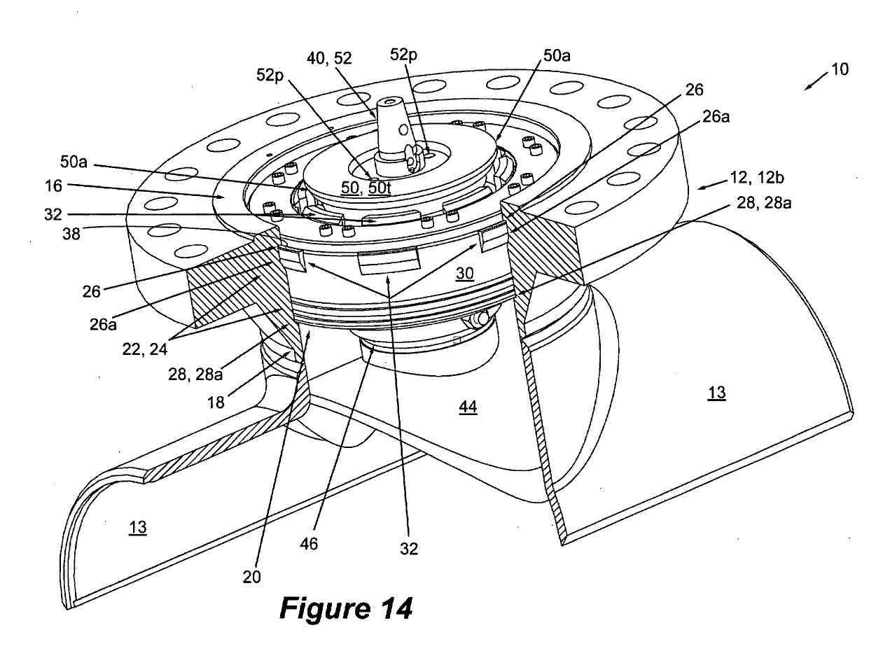

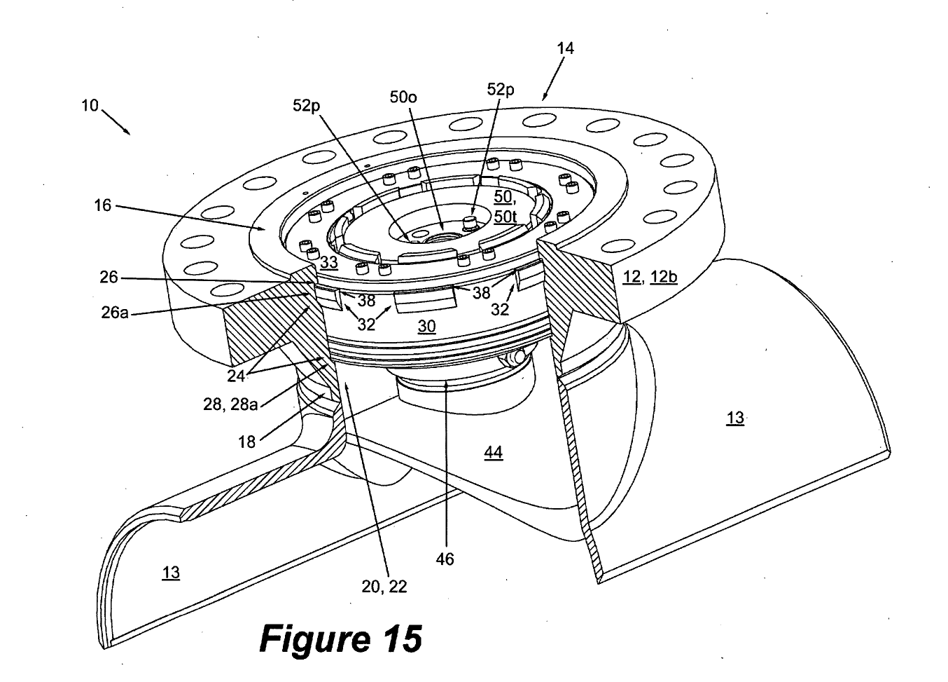

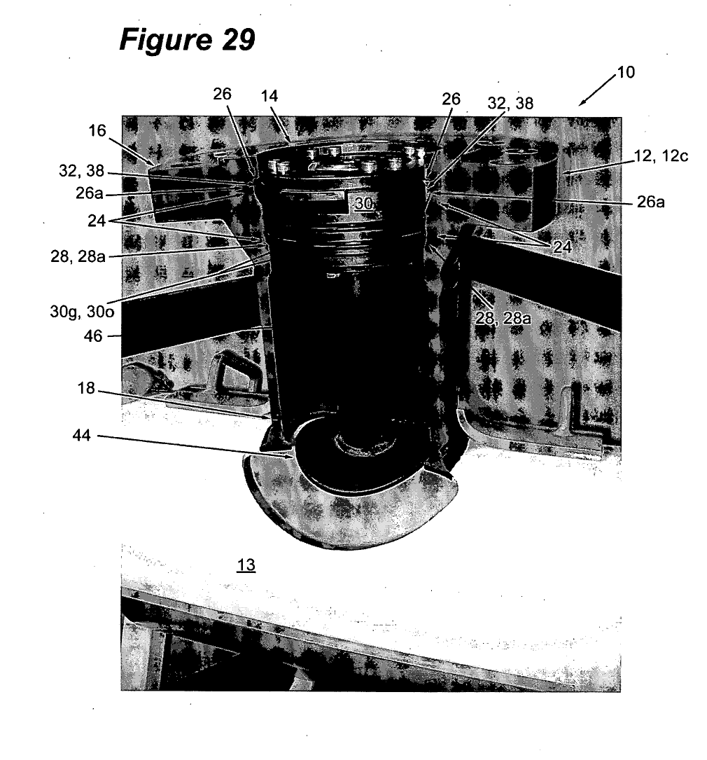

Referring to the Figures, the removable closure system 10 of the present invention comprises a tubular member 12 having a opening 20 for the passage of tools or for flow of liquids or gases and a plug assembly 14. The tubular member 12 may be a nipple 12a (see FIG. 1) which is attachable to a pipeline 13. The invention herein is not limited in use only to a nipple 12a, but is a system for removably placing a plug assembly 14 inside any tubular member 12 or opening 20; the nipple 12a being example of a tubular member and illustrated herein only because it is a typical environment for the application of the removable plug system 10 of this invention. For example, the tubular member 12 may also be a low-profile flange 12b (see FIGS. 14-15), a flanged section of pipe 12c (see FIG. 29) or a section of pipeline (not shown).

The tubular member 12 has an entrance end 16 and a plug end 18. The plug end 18 is shown of the type that is particularly configured for welding to a pipe 13 or to other conduit. The opening 20 defines an internal surface 22 with a profile 24 therein. The profile 24 provides a dog shoulder 26 and a plug stopping shoulder 28. Preferably the dog shoulder 26 is provided by a circumferential groove 26a in the profile 24 and the plug stopping shoulder 28 is provided by a circumferential ledge 28a on the profile 24. Preferably, the dog shoulder 26 is closer to the entrance end 16, compared to the plug stopping shoulder 28 and the shoulders 24, 26 face towards each other.

The plug assembly 14 comprises a plug or plug body 30 having an external surface and being removably and sealably receivable within the tubular member 12 and a plurality of dogs 32. Preferably the dogs 32 are held in place by a top plate or top ring 33 (as shown in the Figures). The dogs 32 are able to radially deflect between an expanded state or condition and a contracted or retracted state or condition. Preferably, when in the collapsed condition the outer edge of each dog 32 is substantially even with or within said external surface of the plug 30 and when in the expanded condition the outer edge of each dog 32 is beyond said external surface and receivable within the circumferential groove 26a.

Preferably, the dogs 32 are biased outward, to the expanded state, by a pair of springs 34 placed in spring cavities 36 inside each of the dogs 32 and wherein one end of the spring engages one end 36a of the spring cavity 36 and the other end of the spring engages a projection 30a on the plug assembly 30, said projection 30a being receivable in the cavity 36. More preferably, the contracting of the dogs 32, to enable passage of the plug assembly 14 past the dog shoulder 26, is facilitated by the shape of the profile 24 and the shape of the dogs 32 (as shown in the Figures), the dogs 32 pushing against the profile 24 as the assembly 14 is inserted into the tubular member 12, overcoming the force of the springs 34 and moving the dogs to the contracted state.

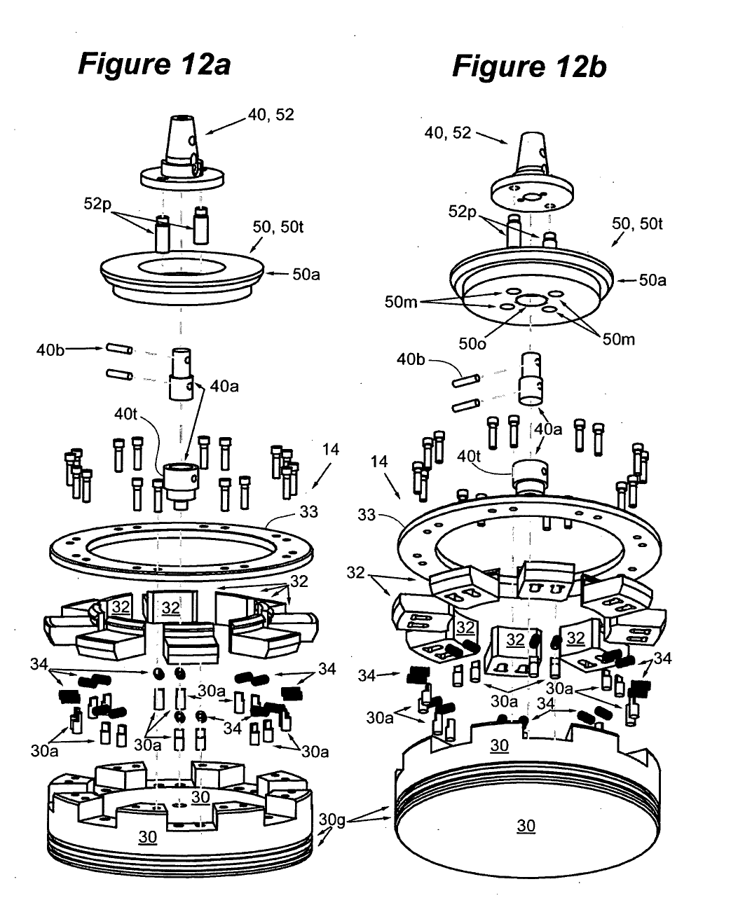

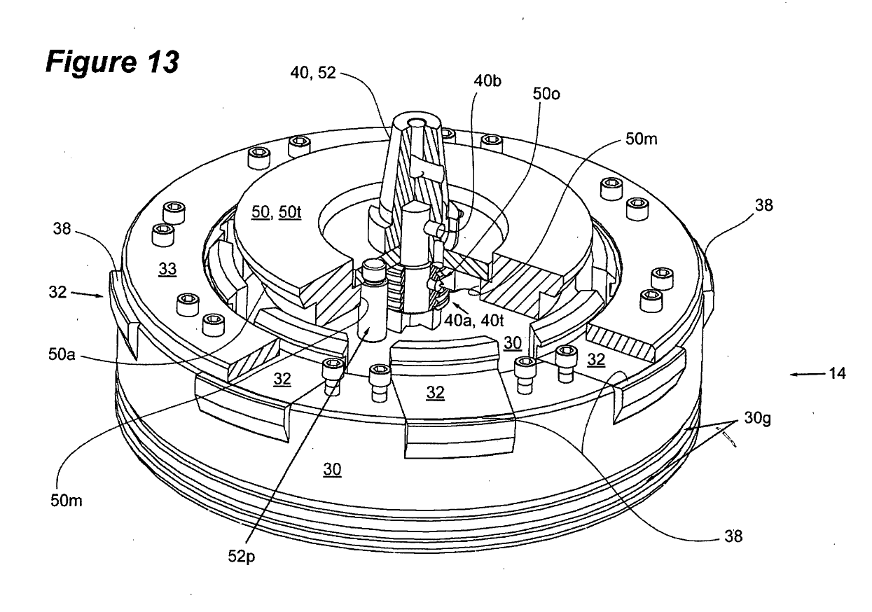

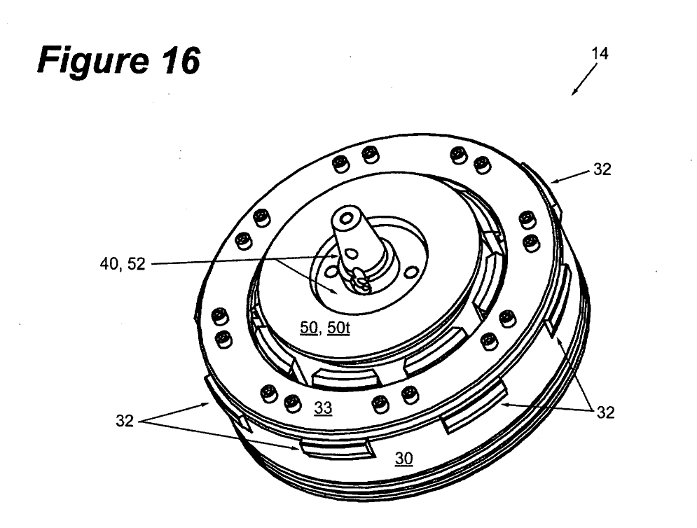

In another embodiment, the dogs 32 are biased outward, to the expanded state, by a lock ring 50 (see FIGS. 12a-18, 23-24 and 26-27). Preferably the lock ring 50 has an external dog-engaging circumferential ledge 50a, said ledge 50a causing the dogs 32 to bias outward when the lock ring 50 is positioned between the dogs 32 and against the plug 30. More preferably the dog-engaging circumferential ledge 50a has a wedge or a frusto-conical aspect to its surface to fascilitate engagement with the dogs 32 (see FIG. 13).

In one embodiment, the lock ring 50 further comprises an internal threaded opening 50o to match the external threads 40t of a partially treaded shear post 40a of a setting tool 40 or arbour 52 (see FIG. 13). In this embodiment the lock ring 50 is mounted on the setting tool 40 or arbour 52 and on the treaded shearing post 40a. Rotational forces or torque are transferred from the setting tool 40 or arbour 52 to the lock ring 50, so that rotation of the setting tool 40 or arbour 52 causes the lock ring 50 to be treaded down the shearing post 40a and positioned between the dogs 32 (see FIGS. 12a-14). Preferably the rotational force or torque from the arbour 52 is transferred to the lock ring 50 by means of arbour posts 52p fastened to the arbour 52 and extending through openings 50m in the lock ring 50 (see FIGS. 12a-13). Thus, in this embodiment, the dogs 32 are moved outward, to the expanded state, by the lock ring 50 being rotated down the threaded section 40t of the shearing post 40a, engaging the dogs 32 and biasing them outward. Once the plug assembly 14 is removably secured in the tubular member 12, the shear pin 40b, connecting the arbour 52 to the shearing post 40a, is sheared (preferably by additional application of torque to the arbour 52 after the lock ring 50 is positioned between the dogs 32 and engages the plug 30). Once the shear pin 40b is sheared, the arbour 52 is free to be lifted from the plug assembly 14 leaving the lock ring 50 positioned between the dogs 32.

Preferably, the dogs 32 each have an outer edge or surface 38 which is suitable for engaging the dog shoulder 26 when the dogs 32 are in the expanded state, the surface 38 assisting in securing the plug assembly 30.

The diameter of the plug assembly 14, regardless of the state of radial deflection of the dogs 32, is such that it cannot pass through the tubular member 12 past the plug stopping shoulder 28. The plug stopping shoulder 28 thus functions as a stop to retain the plug assembly 14 and prevent further axial movement of the assembly 14 through the tubular member 12, reducing or eliminating the chance of the plug falling in the pipe 13. Furthermore, the diameter of the plug assembly 14, when the dogs 32 are in the contracted state, is such that it can pass through the tubular member 12 past the dog shoulder 26.

Preferably, the plug assembly 14 is removably secured, inside the tubular member 12, as follows:
inserting the assembly 14, plug 30 first, into the entrance end 16 of the tubular member 12;
advancing the assembly 14, with the plug 30 first, past the dog shoulder 26 and towards the plug stopping shoulder 28;
contracting the dogs 32 as they passes the dog shoulder 26;
resting the plug 30 against the plug stopping shoulder 28; and
expanding the dogs 32 so that surfaces 38 engage the dog shoulder 26 (see FIGS. 14, 15, 17b and 29).

Preferably, a lock ring 50, having an external dog-engaging circumferential surface 50s and being of such dimensions so as to be positionable between the dogs 32 in their expanded state and against the plug 30, is employed to keep the dogs 32 in their expanded condition once the plug assembly 14 is removably secured inside the tubular member 12. The lock ring 50, by ensuring that the dogs 32 will continue to engage the dog shoulder 26 while the assembly 14 is in the tubular member 12, advantageously provides an additional safety feature and allows the system 10 to withstand great pressures.

Once the plug assembly 14 is set inside the tubular member 12 it may be removed by reversing the above steps: contracting the dog 32 and disengaging the surfaces 38 from the dog shoulder 26, retracting the assembly 14 past the dog shoulder 26 and removing it from the tubular member 12.

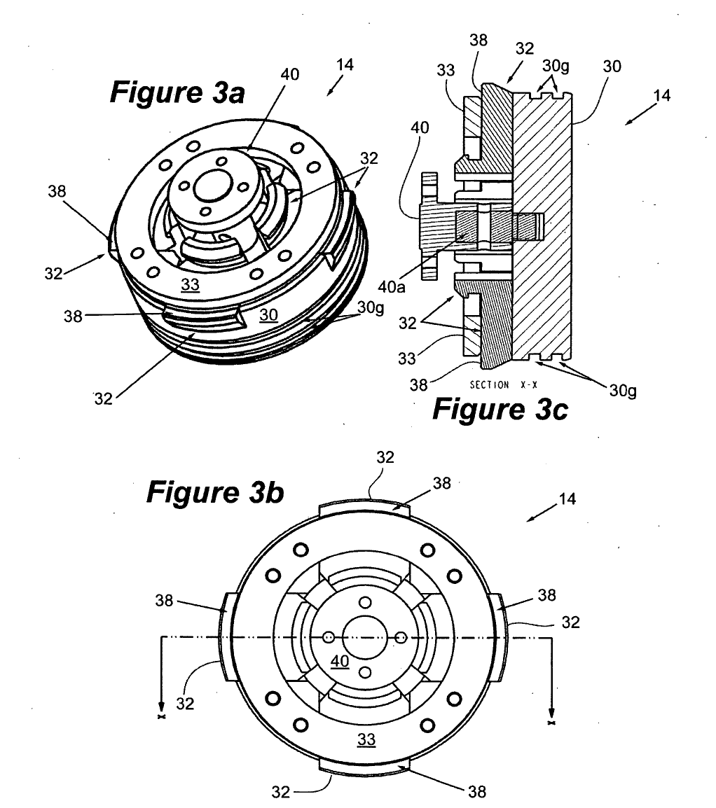

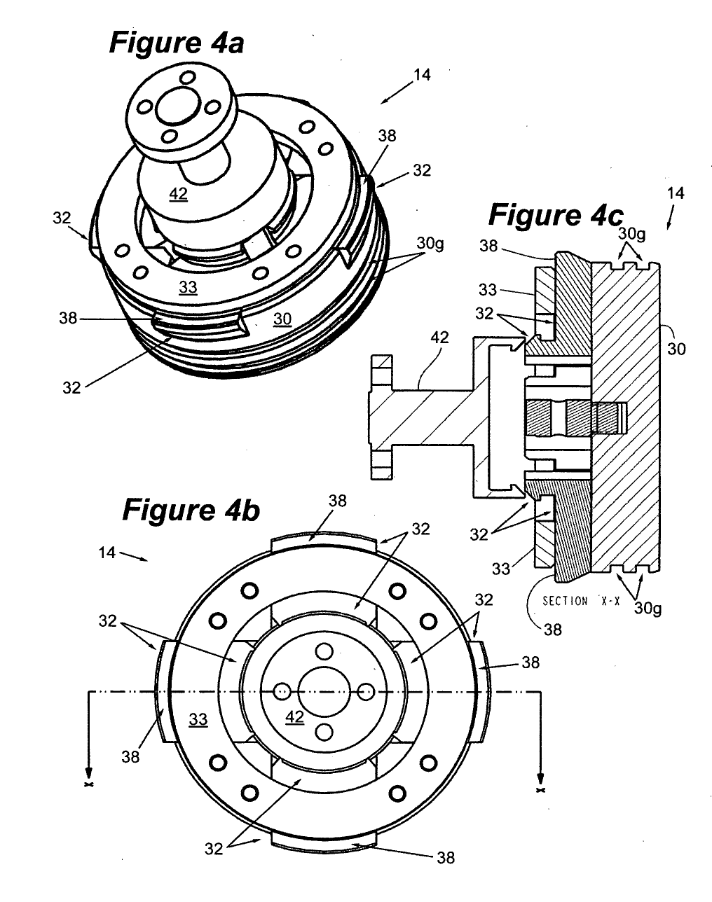

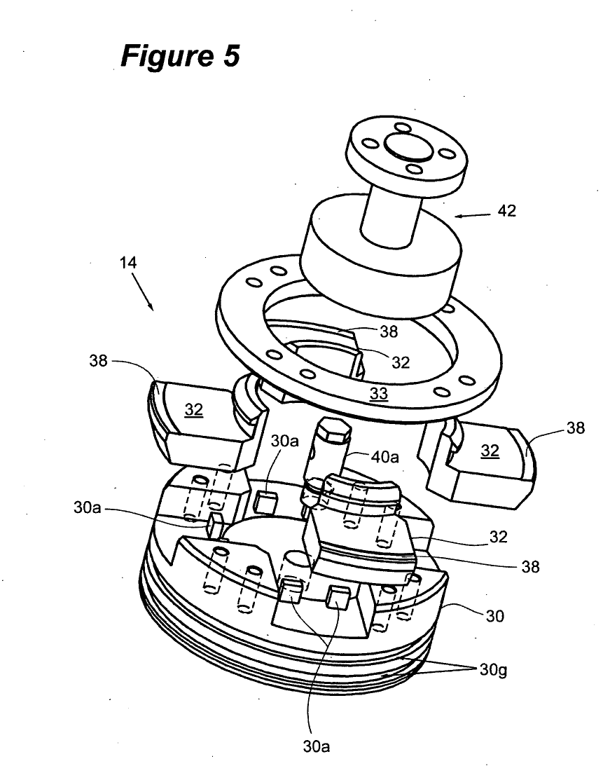

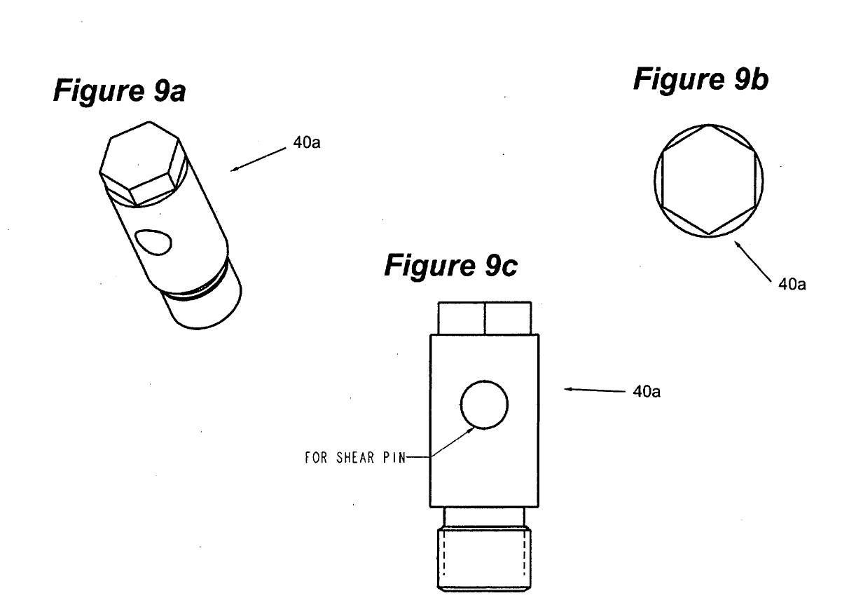

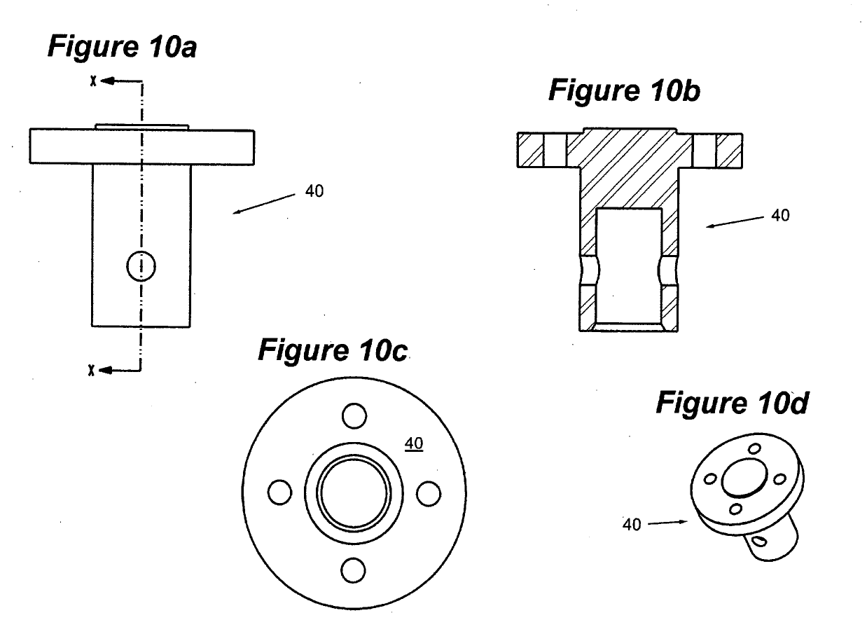

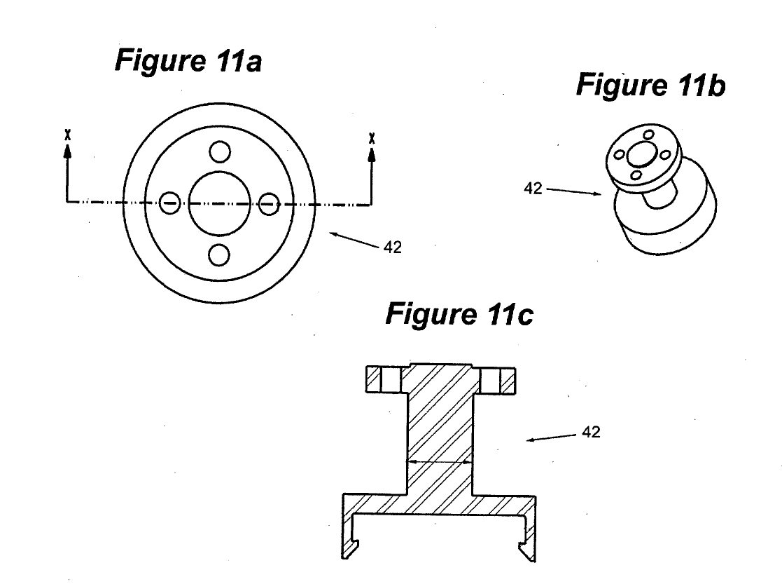

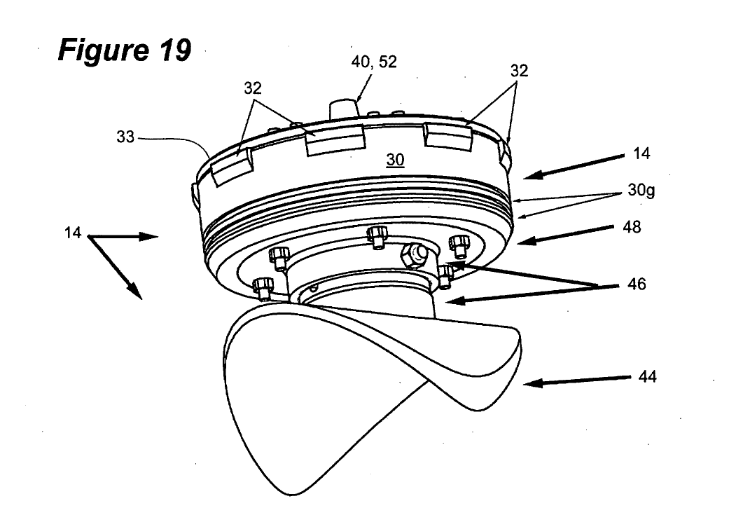

Preferably a setting tool 40 is used to insert and advance a plug assembly 14 through the tubular member 12 (see FIGS. 3a-3c, 9a-10d, 12a-14, 16-24). More preferably, the setting tool 40 further comprises a shear post 40a and shear pin 40b to assist with disconnecting the setting tool 40 from the plug assembly 14 after insertion of the plug assembly 14. Setting tools having shear posts and shear pins are well known to those skilled in the art. Even more preferably, a retrieval tool 42 is used to contract the dogs 32 and remove the plug assembly 14 from the tubular member 12 (see FIGS. 4a-5 and 11a-11c).

The plug assembly 14 may comprise either a flow-through type of plug (not shown), to partially close the tubular member 12, or a solid plug 30 to completely close the tubular member 12.

Preferably, one or more circumferential grooves 30g are provided on the external circumferential surface of the plug 30, each groove receiving an O-ring or other form of sealing gasket 30o. Advantageously, the o-ring or sealing gasket 30o further improves the sealing capability of the plug assembly 14, so as to ensure against leakage of fluids or gases past the plug assembly 14.

Various Embodiments of the Plug Assembly

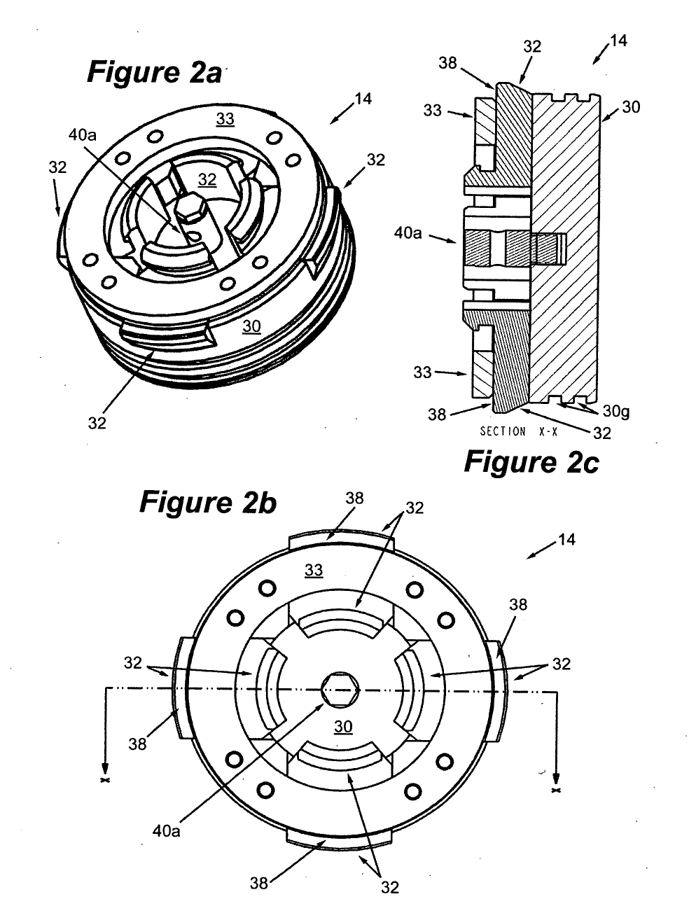

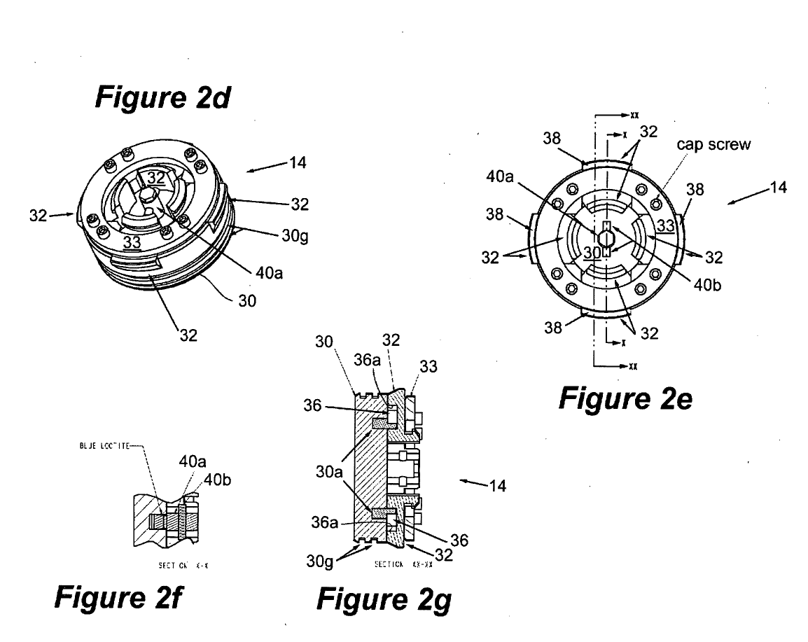

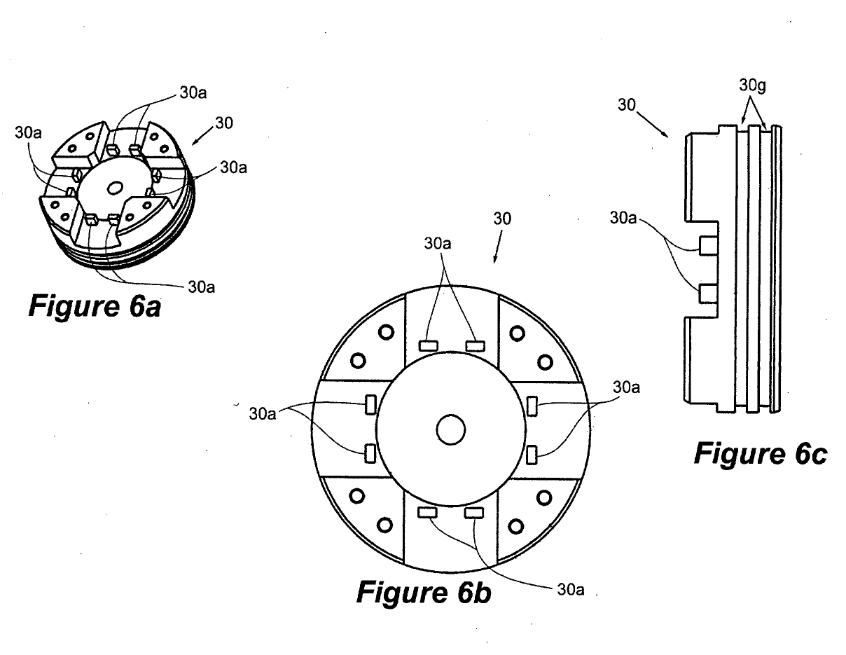

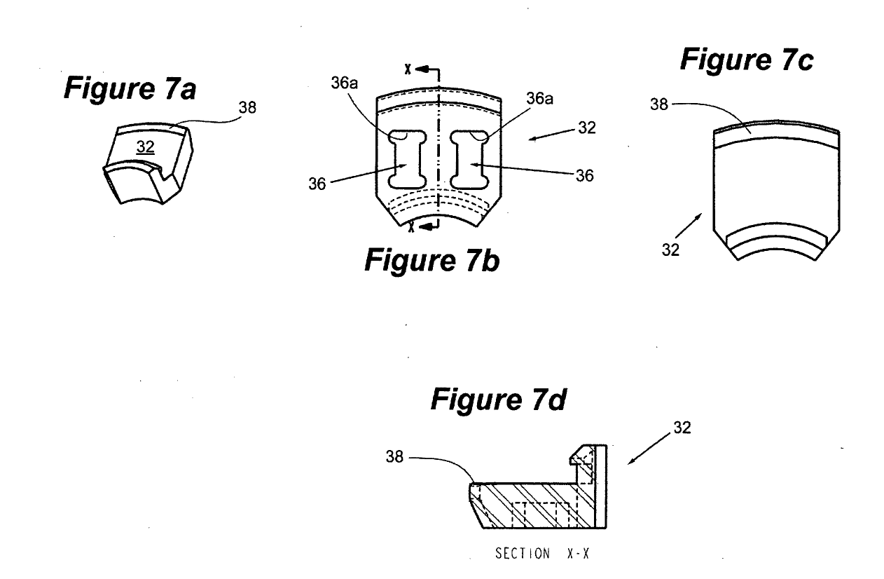

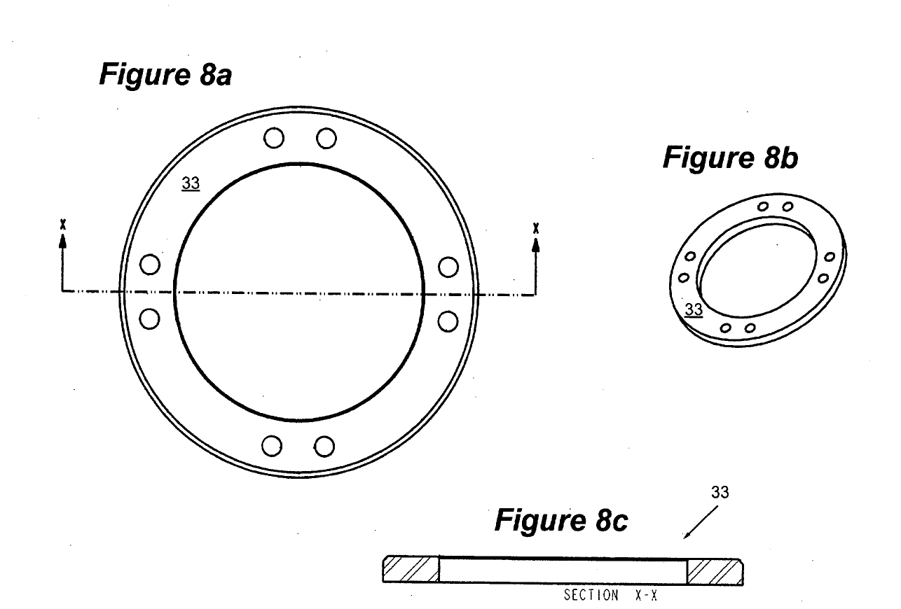

FIGS. 2a to 8c illustrate one embodiment of a plug assembly 14 and FIGS. 12a-13 illustrate a second embodiment of a plug assembly 14.

FIGS. 14-16 illustrate a third embodiment of a plug assembly 14, having a pig deflector or coupon 44 attached below the plug 30 by means of a connecting flange or pig deflector flange 46. The pig deflector 44 is preferably made from the coupon cut from the main pipe 13 during hot tap operations. Advantageously the pig deflector 44 prevents pipeline pigs from entering, or getting caught, on the opening into the branch line 12 into which the plug is placed.

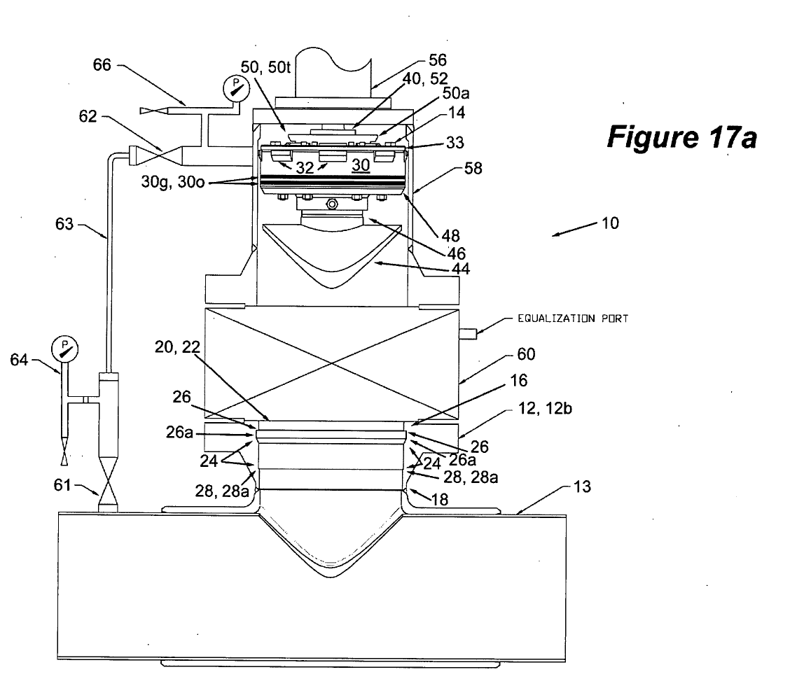

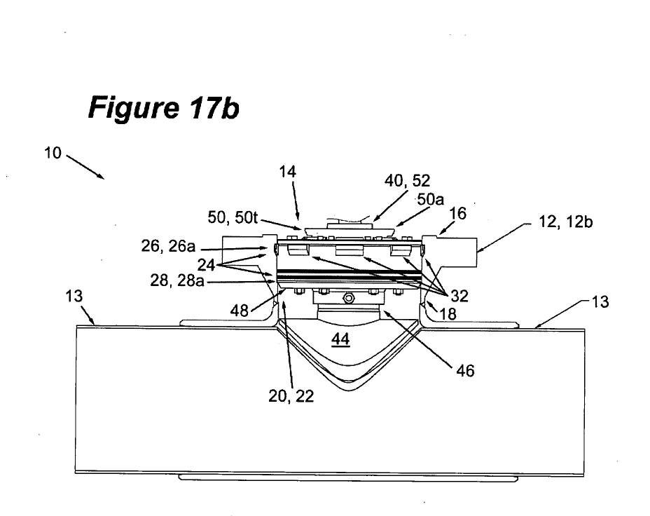

FIGS. 17a-19 illustrate a fourth embodiment of a plug assembly 14, wherein an alignment ring 48 is provided around the pig deflector flange 46 near the plug 30. Preferably the alignment ring 48 is heat-shrunk around the pig deflector flange 46. The alignment ring 48 is tapered to prevent the plug assembly 14 from getting stuck as the hot tap machine lowers the plug assembly 14 into position.

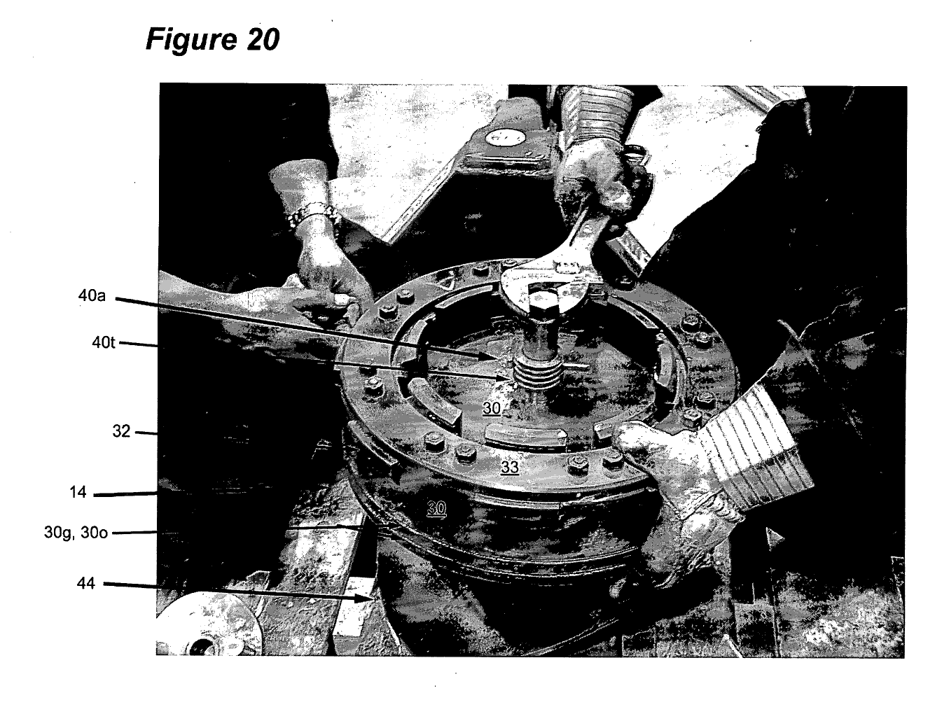

FIGS. 20-28 illustrate a fifth embodiment of a plug assembly 14, with a pig deflector 44 but without an alignment ring.

FIG. 29 is a partially sectioned perspective view of a sixth embodiment of a plug assembly, which is similar to the fourth embodiment shown in FIGS. 17a-19 but with a longer pig deflector flange 46 between the plug 30 and the pig deflector 44 and a third embodiment of the tubular member 12c.

Method of Plug Assembly Installation in a Hot Tapping Application

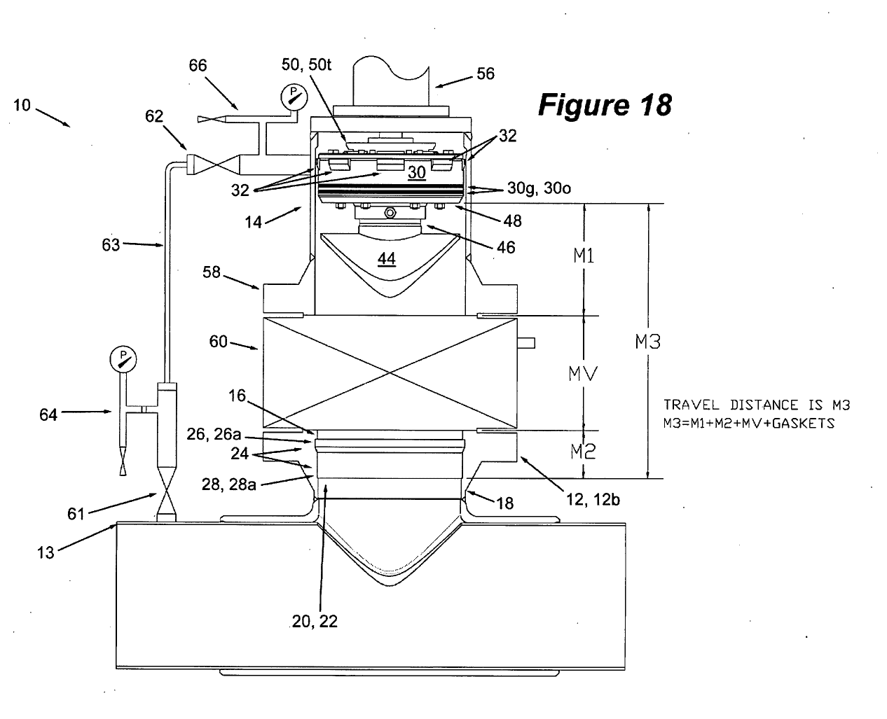

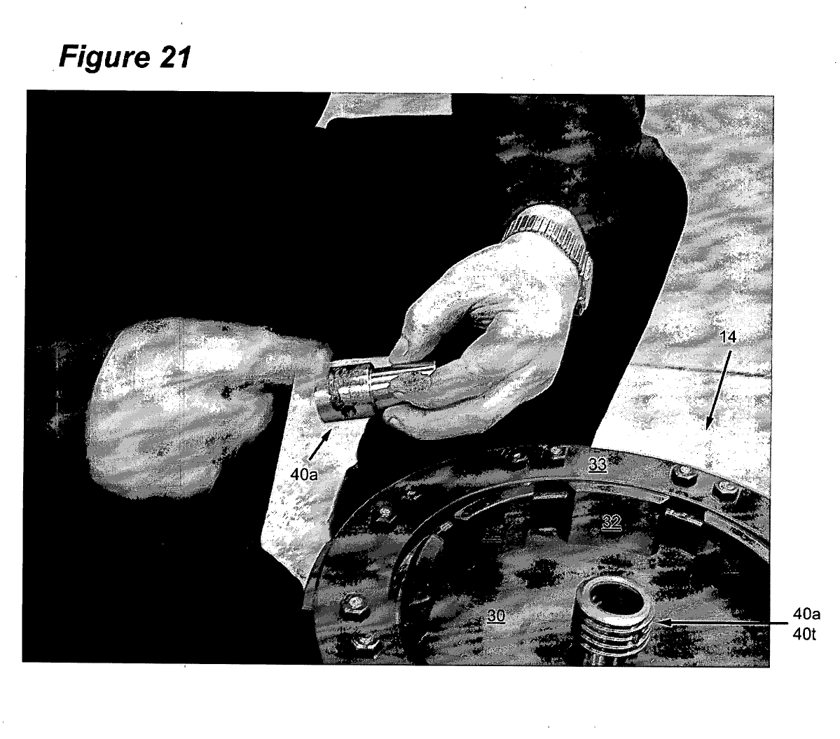

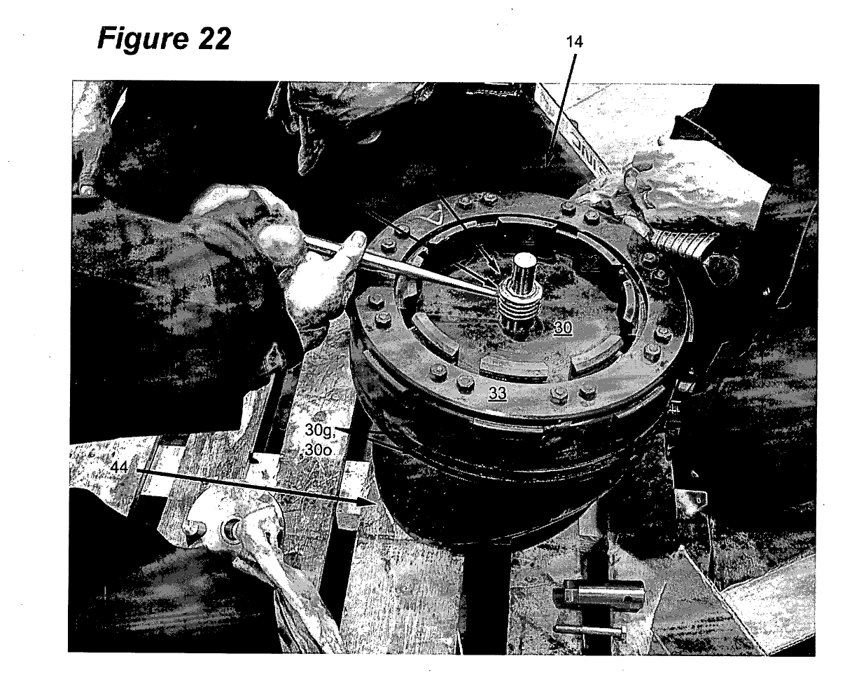

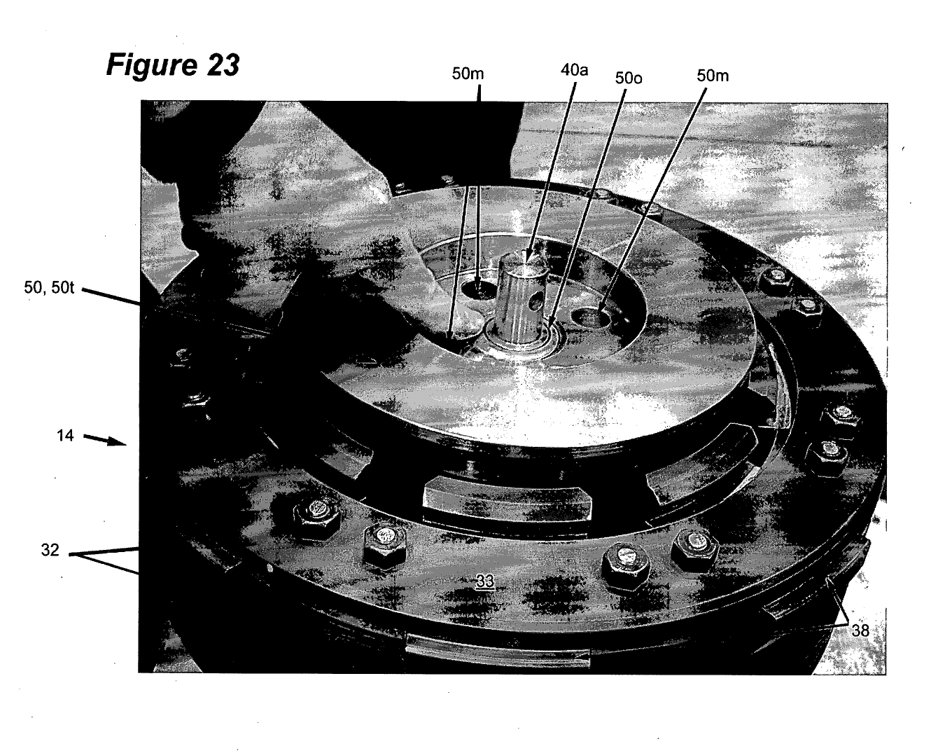

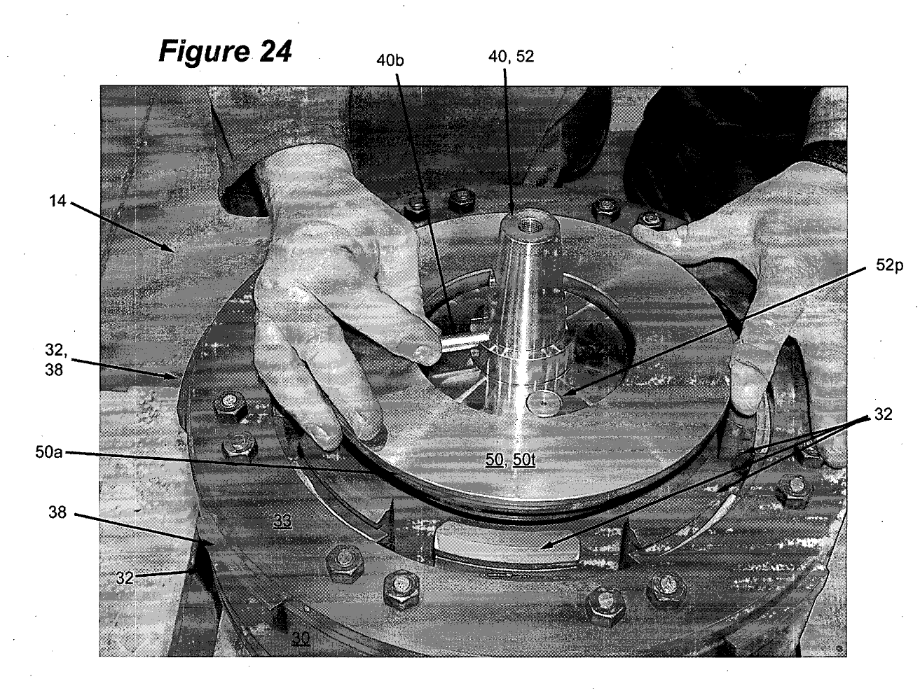

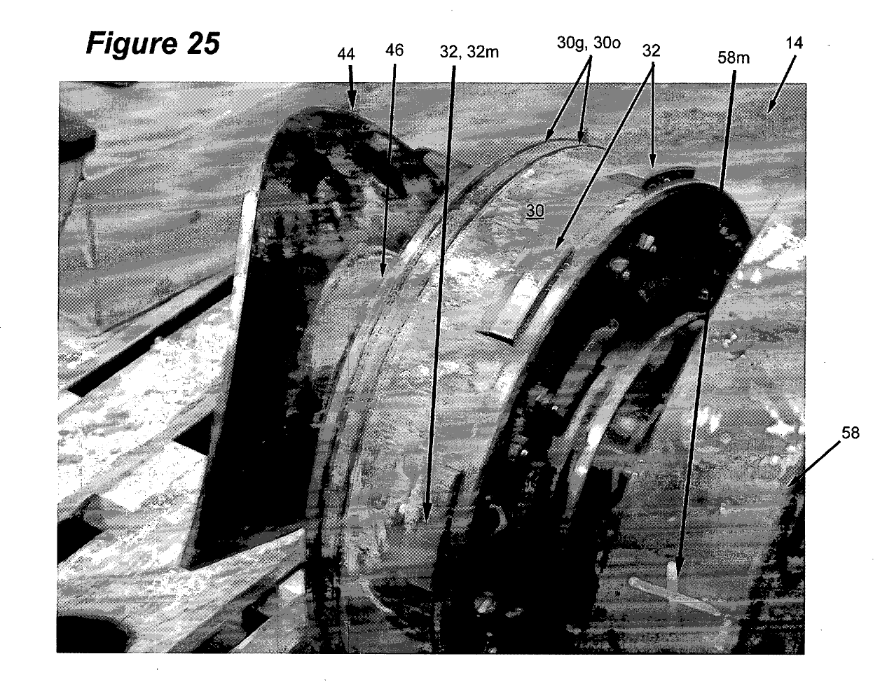

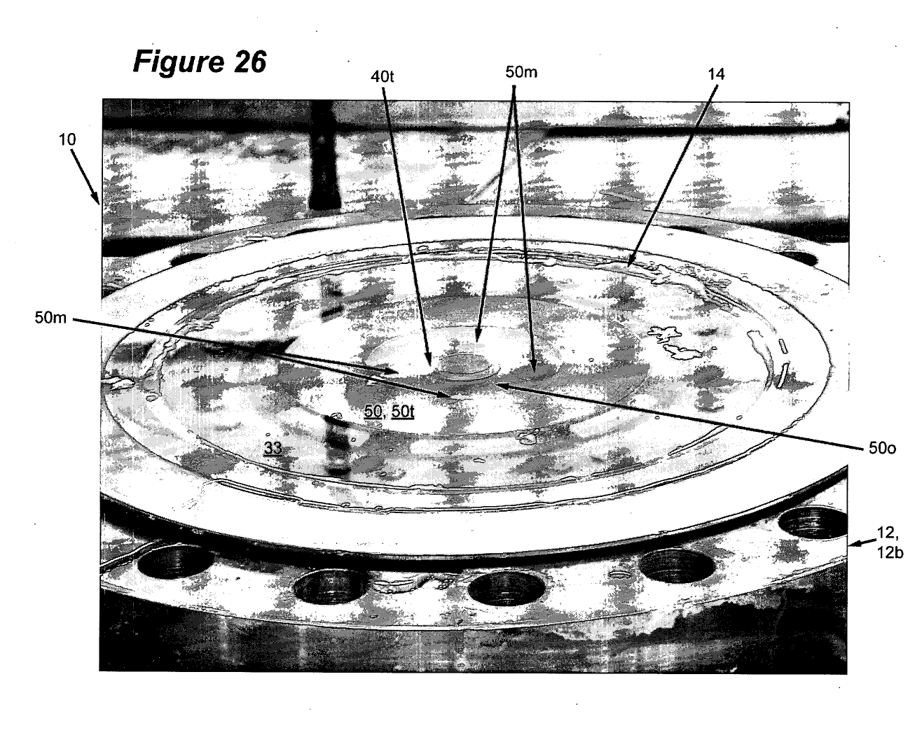

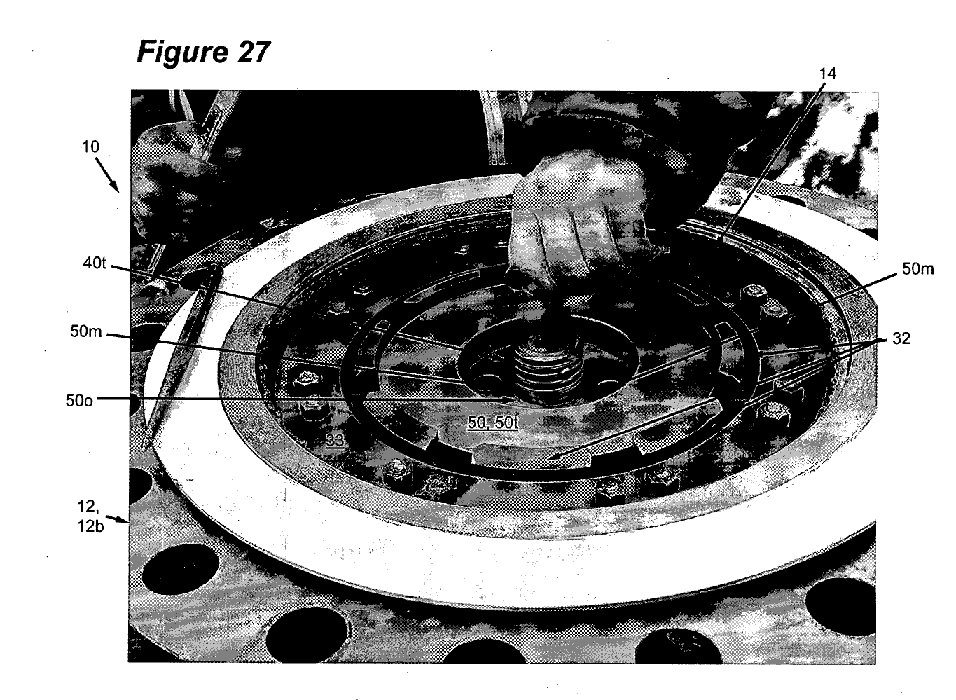

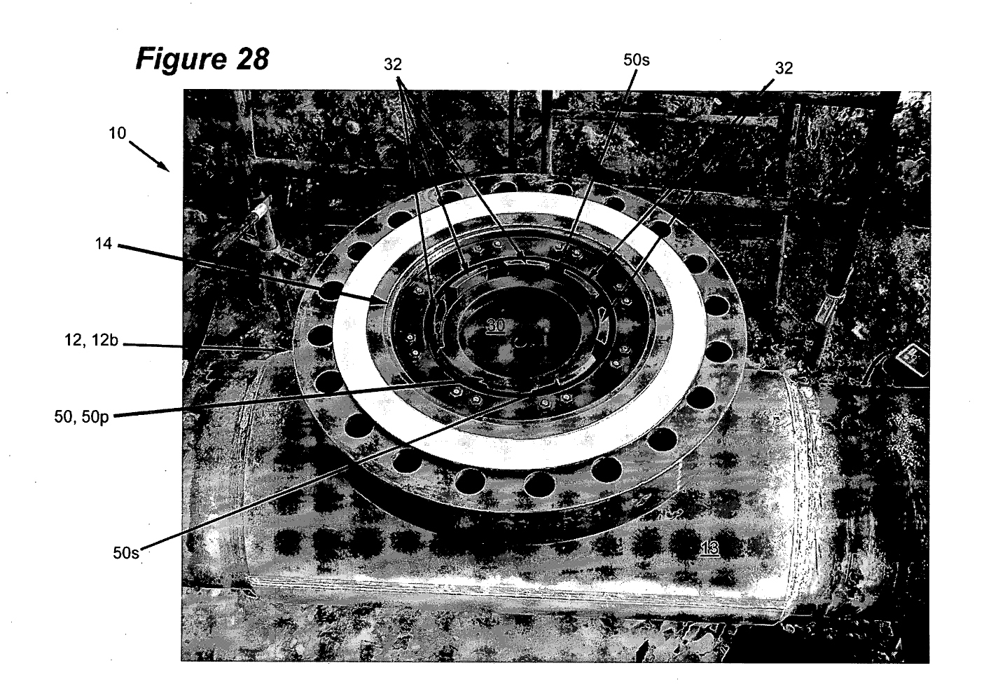

FIGS. 17a-18 and 20-28 illustrate one method of installing, or removably securing, a plug assembly 14 of the present invention into a tubular member 12 during hot tapping operations, the method comprising the following steps:
1) Threading a two-piece shear post 40a onto the plug 30 (see FIG. 20). Preferably, Moly-lube™ lubricant is applied between the two pieces of the post 40a (see FIG. 21).
3) Inserting nylon shear pin 40b into place, through the two pieces of the shear post 40a (see FIG. 22).
4) Turning a temporary lock ring 50t onto the shear post 40a until ring 50t is sitting just below the top of the shear post (see FIG. 23).
5) Preferably checking that the dogs 32 can still slide in and out (i.e. that the temporary lock ring 50t has not actually locked the dogs 32 yet).
6) Sliding an arbour 52 onto the two piece shear post 40a (the arbour 52 functioning as a setting tool 40);
7) Inserting a steel pin 54 through the arbour 52 and post 40a (see FIG. 24). Preferably, covering pin 54 in grease first to help prevent it from falling out.
8) Attaching the plug assembly 14 to a hot tap machine 56 via the arbour 52.
9) Preferably installing a retaining security pin (not shown) to keep the arbour 52 on the hot tap machine 56.
10) Retracting the hot tap machine 56 until the bottom of the plug 30 is distance M1 away from the open end of a spool adaptor flange 58 (see FIG. 18).
11) Preferably marking a measuring rod (not shown), preferably with electrical tape.
12) Preferably marking the distance M3 (see FIG. 18) on the measuring rod, also preferably with electrical tape.
13) Rotating the plug assembly 14 so that a marked dog 32m is lined up with a two-hole mark 58m on the spool adaptor flange 58 (see FIG. 25).
14) Bolting the spool adaptor flange 58 onto a valve 60, with the two-hole mark 58m lined up with the main line 13. 15) Installing the applicable hoses, manifolds and valves; ensuring that all valves are closed (see FIGS. 17a and 18).
16) Opening valve 62 and allow the system to equalize.
17 Lowering the plug assembly 14 onto the plug stopping shoulder 28 (i.e. move distance M3, preferably measured with the measuring rod) using the hot tap machine 56 (See FIG. 17b).
18) Backing out the hot tap machine 56 to shear the shear pin 40b, preferably out no more than 1″.
19) Lowering the hot tap machine 58, so it pushes the plug assembly 14 down to shoulder 28.
20) Raising the hot tap machine 56 a ¼ turn so that the arbour 52 is no longer pushing against the plug 30.
21) Turn the hot tap machine 56 counter-clockwise direction until the measuring rod has made at least 6 full rotations.
22) Backing out the hot tap machine 56, retracting the drill rod fully.
23) Closing valves 61 and 62.
24). Slowly bleeding off pressure in the hose 63 using manifold 64.
25) Reducing the pressure in the spool adaptor flange 58 to 400 psi using manifold 66. Preferably, holding the pressure for 10 minutes while watching for any pressure increase.
26) Slowly bleeding off the spool adaptor flange 58, using manifold 66.
27) Removing the hose 63.
28) Unbolting the spool adaptor flange 58 from valve 60.
29) Preferably inspecting the temporary lock ring 50t. Preferably, the temporary lock ring 50t should be against the plug 30, and none of the dogs 32 should be touching it; because otherwise it means that the temporary lock ring 50t forced the dogs 32 out during installation and that the springs on the underside of the dogs 32 were not sufficient to push them out; e.g. due to obstruction within the branch line, or spring failure (see FIG. 26, valve 60 not shown). If the temporary lock ring 50t is forced against some or all of the dogs 32, then this ring 50t should not be removed, to ensure that the dogs 32 will continue to engage the dog shoulder 26 in the tubular member 12.
30) Removing the valve 60.
31) Removing the shear post 40a (see FIG. 27).
32) If the temporary ring 50t is not engaging one or more of the dogs 32, preferably replace the temporary lock ring with a permanent lock ring 50p (see FIG. 28). Advantageously, the temporary lock ring 50t can then be re-used on subsequent installations and the dogs 32 of the installed plug assembly 14 are secured by a less expensive ring 50p. Either of the lock rings 50t, 50p will ensure that the dogs 32 remain in place, even if subjected to vibration or other loading, thereby providing an additional safety feature in installations where there are high pressures in the pipe 13.

Other methods of plug installation are known to those skilled in the art.

1. A removable closure system comprising:
a tubular member having an internal surface providing a dog shoulder and a plug stopping shoulder; and
a plug assembly, having a plug suitable for insertion through the tubular member and having a plurality of dogs moveable between a collapsed and an expanded condition, the collapsed condition suitable for insertion of the plug assembly through the tubular member past the dog shoulder and the expanded condition suitable for engaging the dog shoulder; and
wherein, when the plug assembly is placed in the tubular member against the plug stopping shoulder, and the dogs are in the expanded condition engaging the dog shoulder, the plug assembly is removably secured in the tubular member.

2. A removable closure system according to claim 1 wherein said tubular member is a nipple.

3. A removable closure system according to claim 1 wherein said tubular member is a flange member.

4. A removable closure system according to claim 1 wherein the dog shoulder is provided by a circumferential groove.

5. A removable closure system according to claim 1 wherein the plug stopping shoulder is provided by a circumferential ledge.

6. A removable closure system according to claim 1 further comprising springs to move the dogs to the expanded condition.

7. A removable closure system according to claim 1 further comprising a lock ring.

8. A removable closure system according to claim 1 wherein the plug assembly further comprises a pig deflector depending from the plug.

9. A removable closure system according to claim 8 wherein the pig deflector depends from the plug by means of a pig deflector flange.

10. A removable closure system according to claim 9 wherein the plug assembly further comprises an alignment ring around the pig deflector flange.

11. A plug assembly for use in a tubular member having an internal surface providing a dog shoulder and a plug stopping shoulder, the plug assembly comprising:
a plug suitable for insertion through the tubular member; and
a plurality of dogs moveable between a collapsed and an expanded condition, the collapsed condition suitable for insertion of the plug assembly through the tubular member past the dog shoulder and the expanded condition suitable for engaging the dog shoulder;
wherein, when the plug assembly is placed in the tubular member and against the plug stopping shoulder, and the dogs are in the expanded condition engaging the dog shoulder, the plug assembly is removably secured in the tubular member.

12. A plug assembly according to claim 11 wherein said tubular member is a nipple.

13. A plug assembly according to claim 11 wherein said tubular member is a flange member.

14. A plug assembly according to claim 11 wherein the dog shoulder is provided by a circumferential groove.

15. A plug assembly according to claim 11 wherein the plug stopping shoulder is provided by a circumferential ledge.

16. A plug assembly according to claim 11 further comprising springs to move the dogs to the expanded condition.

17. A plug assembly according to claim 11 further comprising a lock ring.

18. A plug assembly according to claim 11 further comprising a pig deflector depending from the plug.

19. A plug assembly according to claim 18 wherein the pig deflector depends from the plug by means of a pig deflector flange.

20. A plug assembly according to claim 19 further comprising an alignment ring around the pig deflector flange.

21. A plug assembly according to claim 17 wherein the lock ring further comprises an external dog-engaging circumferential ledge suitable for moving the dogs to their expanded condition when said lock ring is positioned between the dogs.

22. A plug assembly according to claim 17 wherein the lock ring further comprises an external dog-engaging circumferential surface suitable for keeping the dogs in their expanded condition when the plug assembly is removably secured inside the tubular member and said lock ring is positioned between said expanded dogs.

23. A removable closure system according to claim 7 wherein the lock ring further comprises an external dog-engaging circumferential ledge suitable for moving the dogs to their expanded condition when said lock ring is positioned between the dogs.

24. A removable closure system according to claim 7 wherein the lock ring further comprises an external dog-engaging circumferential surface suitable for keeping the dogs in their expanded condition when the plug assembly is removably secured inside the tubular member and said lock ring is positioned between said expanded dogs.

25. A plug assembly removably positionable in an opening, the opening having a circumferential groove therein, comprising:
a plug having an external surface and being removably and sealably receivable within said opening;
a plurality of dogs, each having an outer edge and moveable between a collapsed condition in which said outer edge of each dog is substantially even with or within said external surface and an expanded condition in which said outer edge of each dog is beyond said external surface and receivable within the circumferential groove of the opening; and
means for moving the dogs between said collapsed and expanded conditions.

26. A plug assembly according to claim 25 wherein the means for moving the dogs between said collapsed and expanded conditions comprises springs.

27. A plug assembly according to claim 25 further comprising a lock ring.

28. A plug assembly according to claim 25 further comprising a pig deflector depending from the plug.

29. A plug assembly according to claim 28 wherein the pig deflector depends from the plug by means of a pig deflector flange.

30. A plug assembly according to claim 29 further comprising an alignment ring around the pig deflector flange.

31. A plug assembly according to claim 27 wherein the means for moving the dogs between said collapsed and expanded conditions comprises an external dog-engaging circumferential ledge on said lock ring, said ledge suitable for moving the dogs to their expanded condition when the lock ring is positioned between the dogs.

32. A plug assembly according to claim 27 wherein the lock ring further comprises an external dog-engaging circumferential surface suitable for keeping the dogs in their expanded condition when the plug assembly is removably secured inside the opening and said lock ring is positioned between said expanded dogs.
